(19) United States
(12) Patent Application Publication
(10) Pub. No.: US 2014/0357356 A1
(43) Pub. Date: Dec. 4, 2014

(54) CHARACTER BATTLE SYSTEM CONTROLLED BY USER'S FLICK MOTION

(71) Applicant: DeNA Co., Ltd., Tokyo (JP)

(72) Inventor: Keiichi HORIE, Tokyo (JP)

(73) Assignee: DeNA Co., Ltd., Tokyo (JP)

(21) Appl. No.: 13/903,941

(22) Filed: May 28, 2013

(51) Int. Cl. A63F 13/00

(52) U.S. Cl. CPC A63F 13/00
USPC 463/31

(57) ABSTRACT

A turn-based battle video game that utilizes a touchscreen to receive inputs from a user. An environment and first character are displayed. A status indicator is displayed adjacent to the first character. An input is received, where the input extends from a first point of the touchscreen corresponding to a position on the status indicator and extends to a second point on the touchscreen, the input having a direction component and a length component, the direction component corresponding to a first direction. A movement of the first character is caused, the movement corresponding to the input.

### BACKGROUND

The present invention relates to video games and methods and systems therefor.

Video games are popular pastime activities. In the past, video games were played on arcade machines, televisions, and computers. More recently, video games are played on portable devices, such as mobile phones and tablets. The video games that are played on portable or mobile devices are sometimes referred to as “mobile video games.” The portable devices (or mobile devices) typically include a touch sensitive display area (e.g., a touchscreen) whereon players can view videos and input commands.

Many mobile video games allow players to play games by inputting commands on the touchscreen. Some of these games are simple in nature. For example, some games, such as ANGRY BIRDS and MARBLES, require mastery of a relatively few, low-level tactical skills and concepts. However, games that involve battle between characters are also popular, such as POKEMON. Such games may integrate various features, such as those involving quests or missions and role-playing, with a battle game system. These games often entail use of more sophisticated character movements in combination with more complex tactical decisions, which can enhance user interest.

However, as games require more complicated actions, the user, especially a so-called light game user, may find it difficult to continue the game. Accordingly, there is a need to improve the ease of controlling a user's character within a battle game system.

### BRIEF SUMMARY

In an embodiment, a turn-based battle video game utilizes a touchscreen to receive inputs from a user. An environment and first character are displayed. A status indicator is displayed adjacent to the first character. An input is received, where the input extends from a first point of the touchscreen corresponding to a position on the status indicator and extends to a second point on the touchscreen, the input having a direction component and a length component, the direction component corresponding to a first direction. A movement of the first character is caused, the movement corresponding to the input

In another embodiment, a turn-based battle game is provided on a mobile device having a touchscreen. An environment including an active first character is displayed on the touchscreen. A status indicator adjacent to the active first character is displayed on the touchscreen. An input is received on the touchscreen. The input extends from a first point on the touchscreen corresponding to a point on the status indicator to a second point on the touchscreen. The input has a direction component corresponding to a first direction and a length component. A movement of the active first character is caused based on the input, and a distance and a direction of the movement of the first character is determined based on the input.

In another embodiment, a program for playing a turn-based battle video game that utilizes a touchscreen to receive inputs from a user is stored on non-transitory computer readable medium. The non-transitory computer medium comprises code for displaying an environment, code for displaying a first character, code for displaying a status indicator adjacent to the first character, code for receiving an input extending from a first point of the touchscreen corresponding to a position on the status indicator and to a second point on the touchscreen, and code for causing a movement of the first character. The input has a direction component and a length component. The direction component corresponds to a first direction. The movement of the first character corresponds to the input.

### BRIEF DESCRIPTION OF THE DRAWINGS

FIG. 1 shows a simplified view of a mobile device having a touchscreen showing a game environment according to an embodiment.

FIG. 2 is a screenshot of a game environment according to an embodiment.

FIG. 3 shows a simplified view of a plurality of second characters, i.e., monsters, provided in a game environment according to an embodiment.

FIG. 4 is another screenshot of a game environment according to an embodiment.

FIG. 5A is a simplified diagram illustrating a mechanism for controlling a character's movement in a battle game on a user device.

FIG. 5B illustrates a mechanism for controlling a character's movement using a status indicator that has a shape of a ring according to another embodiment.

FIG. 5C illustrates a process for determining the direction of a movement of a character according to an embodiment.

FIG. 6 is a screenshot of a game environment showing a control element according to an embodiment.

FIG. 7 is a simplified diagram of a game environment including various game features.

FIG. 8 shows a screen shot of an ally selection screen.

FIG. 9 illustrates a process for playing a game according to an embodiment.

FIG. 10 shows a simplified view of a communications system.

FIG. 11 shows a simplified view of components in a server.

FIG. 12 shows a simplified view of a user device which is a type of user systems.

### DETAILED DESCRIPTION

The present invention relates to video games and methods and systems therefor. In an embodiment, a video game is played on a mobile device having a touchscreen whereon a player can input commands. The video game combines a finger swiping or flicking motion to move a character in a direction in a battle game, with displayed objects for enhancing the usability of a character control mechanism. In addition, the video game may include strategic elements arising from various combinations of character and environment characteristics. The terms “swiping” and “flicking” are used interchangeably herein.

In an embodiment, a video game involves easily and accurately moving a character in a battle game environment. A video game combines finger swiping or flicking an object associated with a character to move the character in a direction. The video game may include strategic elements arising from various combinations of character roles and environment characteristics. The speed, distance, and/or course of the character's movement may be determined based on components of the user input, such as a direction of a finger swipe against a touchscreen, a length of the finger swipe against the touchscreen, an acceleration or speed of the finger swipe against the touch screen, and a duration of the finger swipe or how long the finger is held against the touchscreen. An object comprising a control element that corresponds to the input finger swipe may be displayed to provide the user with information about the character's projected movement.

In an embodiment, a stylus or an object other than a finger may be used to input the swiping command on the touchscreen. In another embodiment, the swiping command may be input using an input device other than a touchscreen, e.g., a mouse, a touch pad, or a motion detector.

The above mechanism for controlling a character's movement may be implemented in a battle game system including relatively sophisticated strategic elements to enhance user interest while providing ease of use. In a game, a quest or mission is provided in which a first character operated by a player, i.e., a user, goes through a predetermined area in a map while playing the game. In the course of the quest, the player may encounter an enemy or second character. The second character may be a non-player character (NPC), such as a computer controlled monster. When the first character encounters the second character, a battle between the first character and the second character may be initiated. In another embodiment, a team battle, for example, a three-on-three battle of characters against monsters, may occur. In an embodiment, the battle is performed in a turn-based battle system in which players' characters take turns to engage in an action in the game.

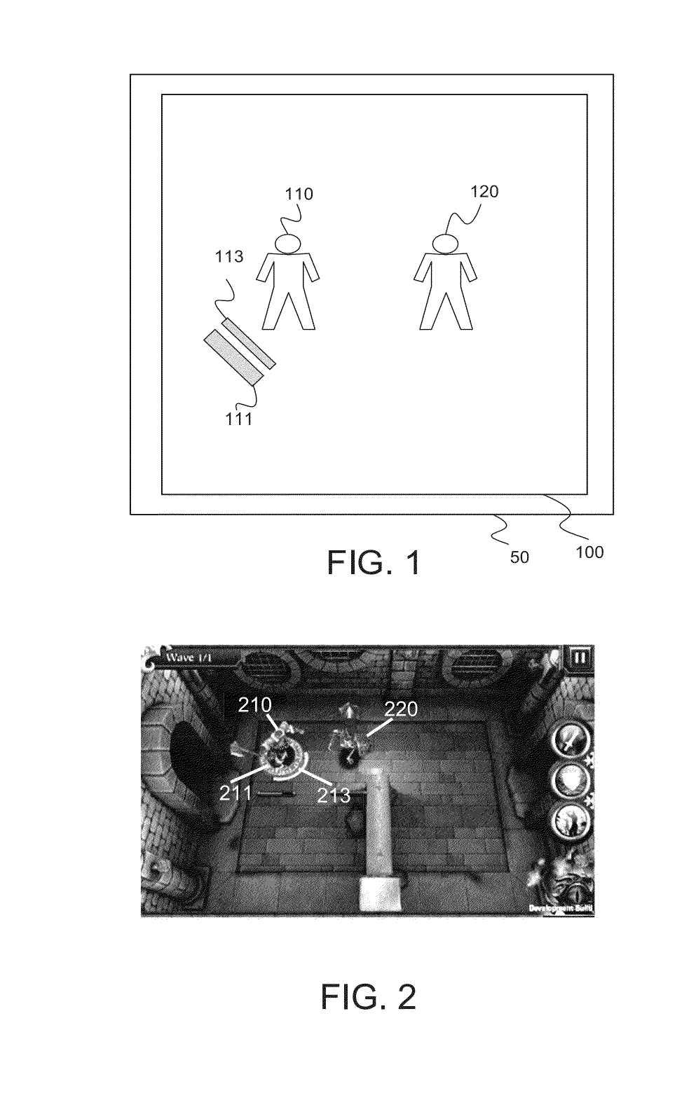

FIG. 1 shows a simplified view of a mobile device 50 having a touchscreen 100 showing a game environment according to an embodiment. In an embodiment, the mobile device 50 is a smartphone or tablet having a touchscreen 100 whereon user commands can be inputted. The touchscreen 100 is an electronic visual display that can detect the presence and location of a touch within the display area. The touch and location detected can be a user's finger, a stylus, or the like.

In an embodiment, a status indicator 111 is displayed adjacent to a first character 110 in a turn-based game. The status indicator 111 is provided adjacent to the first character 110 when the first character 110 is active. That is, the presence of the status indicator 111 adjacent to the first character 110 indicates a player's turn in a turn-based battle game. The status indicator 111 may be provided in a unique color so that the player can be alerted when the character's status is active. In an embodiment, the status indicator 111 indicates to a user that an input may be received at a point of the touchscreen corresponding to a position on or near the status indicator 111 (or the character associated thereto) to move the first character 110. In this embodiment, the status indicator 111 is ring-shaped and encircles the first character 110 so that an input may be received at any point on or near the ring to move the first character 110 in any direction desired by the user.

In an embodiment, the ring is defined into a plurality of arcs where each arc is associated with a direction. The movement of a character (e.g., the first character 110) is based on the relationship between the location of the input made by a user and the arc that is proximate to the input location. For example, the moving direction of the first character 110 may be determined by the arc that is closest to the input location.

A timer 113 associated with the player's turn status may also be provided adjacent to the character 110. The timer 113 indicates the time remaining in an active character's turn, such that a length of the timer 113 varies with the time of the turn of the character 110 in a turn-based game. For example, as the time of the character's turn decreases, the length of the timer 113 may decrease as well. In an embodiment, if the status indicator 111 is ring-shaped, the timer 113 may be in the form of an arc provided along an edge of the ring of the status indicator 111. In an embodiment, when the length of the timer 113 decreases to a predetermined length, it may change colors to indicate to the user that the character's is almost over. By viewing the first object 111 and the timer 113, a player can readily determine visually the turn status of the first character 110.

In an embodiment, the timer 113 and the status indicator 111 may be provided together on the same area. For example, if the status indicator 111 is a ring encircling the first character 110, the timer 113 may be a dot or object that move around the ring to indicate the available time left for the turn. In another example, the timer 113 may be indicated by the changing colors of the status indicator 111.

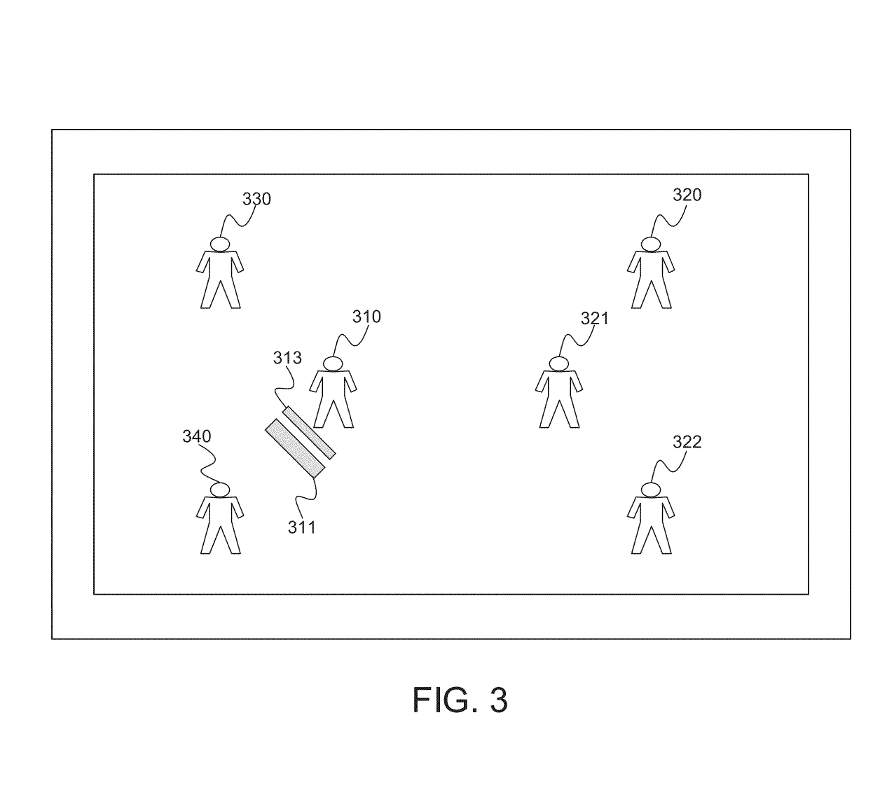

FIG. 2 is a screenshot of a game environment according to an embodiment. In the embodiment shown in FIG. 2, a status indicator 211 is a ring-shaped object encircling an active first character 210. A timer 213 is an arc provided along an edge of the status indicator 211. The status indicator 211 may indicate to a user a position of the touchscreen where a command for controlling a movement of the character 210 may be input. As will be described in greater detail below, the input may have a direction component that corresponds to a direction in which the user would like the character 210 to move. Thus, by providing the status indicator 211 as a ring encircling the first character 210, the user can easily determine where to input a command to move the character 210 in any desired direction.

A second character 220, such as a monster, may be positioned opposite to the first character 210 in a battle field provided in the game environment. However, in another embodiment, characters are not placed opposite to each other, hut are placed at predetermined positions. In an embodiment, the second character 220 is static until engaged by the first character 210, but the second character 220 may also move or initiate an attack on the first character 210 to increase the complexity of the game.

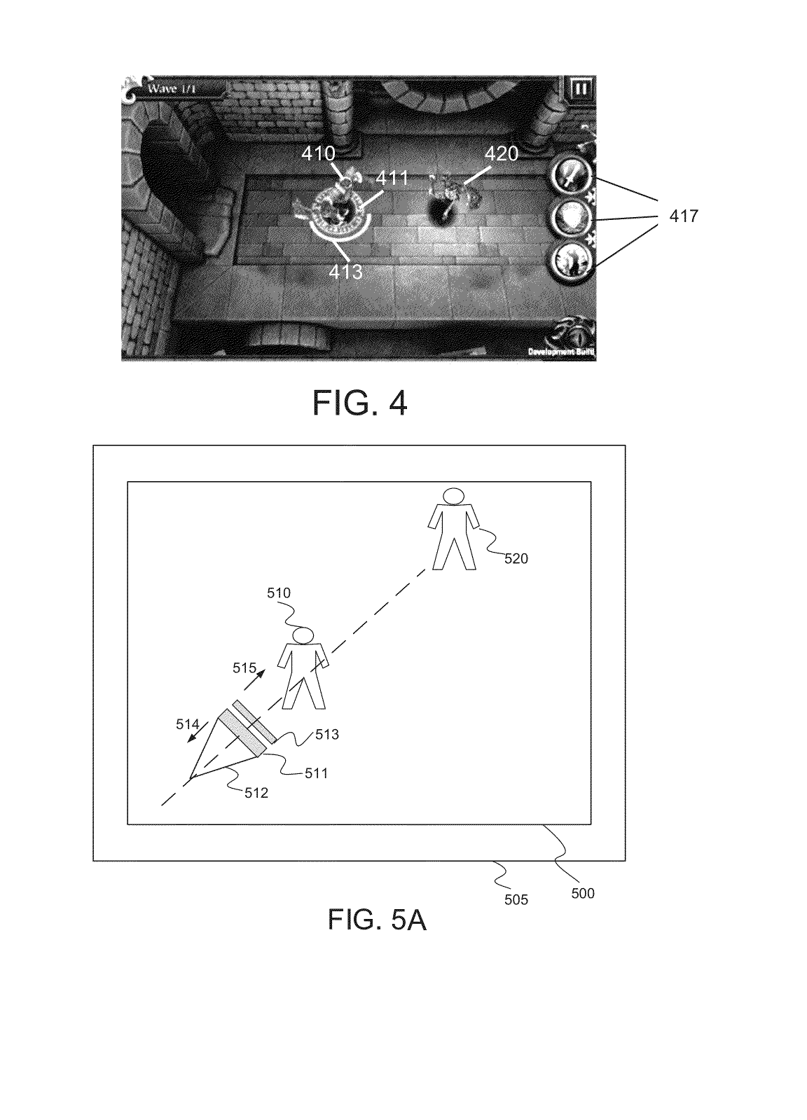

Additionally, as shown in FIG. 3, a plurality of second characters 320, 321, and 322, i.e., monsters, may be provided. A first character 310 may battle against the wave of monsters during the first character's turn. If the game includes a multi-player battle, other characters 330 and 340, which may be played by other users, may take turns battling against the wave of monsters 320, 321, and 322. In this way, each player's character takes turns in the battle game. Once all of the monsters in a wave are killed, another wave of monsters may come. Turns may alternate from characters to monsters during the course of the battle. In a more complex game, a mechanism for easily and accurately controlling the first character's movement is increasingly important, particularly to a user new to such games that may not be familiar with navigating more advanced game features.

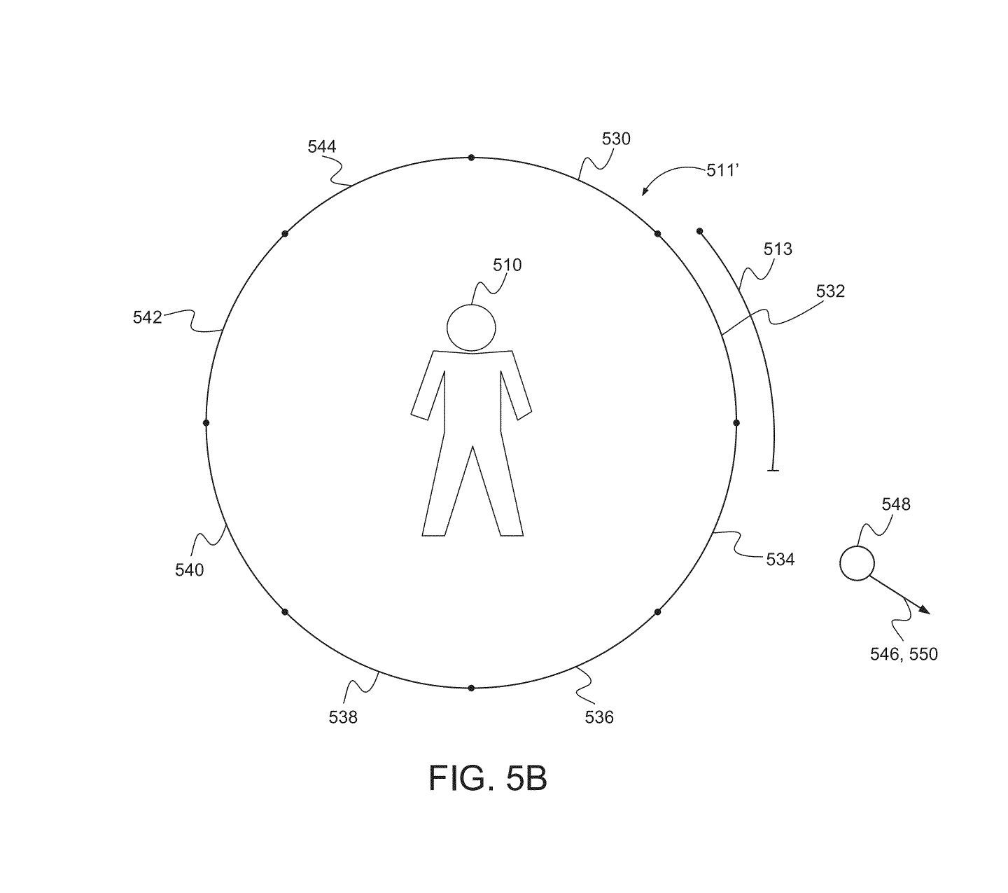

FIG. 4 is another screenshot of a game environment according to an embodiment, In a game according to an embodiment, each character has a parameter used for the battle, such as offensive effectiveness and defensive strength. These parameters may be represented by numerical values such as a basic attack value and a hit point (HP) value. As shown in FIG. 4, in a game, a first character 410 and a second character 420 may be engaged in a battle. The first character 410 may be associated with a class that defines the character's role, including, for example, the equipment and the skills the character may use in battle.

Thus, if the equipment associated with the character's role is range equipment, the character may shoot a projectile in a forward motion at the end of the character's movement to attack the enemy, while another role may collide with the enemy to inflict damage. Such equipment and skills associated with the class of the character 410 are represented by icons 417 on the right side of the screenshot shown in FIG. 4. In addition, a special skill may be associated with the first character 410. In an embodiment, the special skill is activated after a predetermined number of the character's turn or after a predetermined time period of the battle.

In a game according to an embodiment, characters and monsters may have a level which indicates the strength of the character or monster. The first character's level may correspond to information about the first character's success in a previous battle or quest, and a monster's level may be dependent on the first character's level. If the first character 410 easily completes a quest five times while maintaining the same level, the monster's level becomes higher. In other words, if the first character 410 completes the mission and maintains an HP value that is higher than a predetermined value then the level of the monster may increase. When a character's level is incremented, the number of times the mission is completed is reset to zero or the battle result is reset.

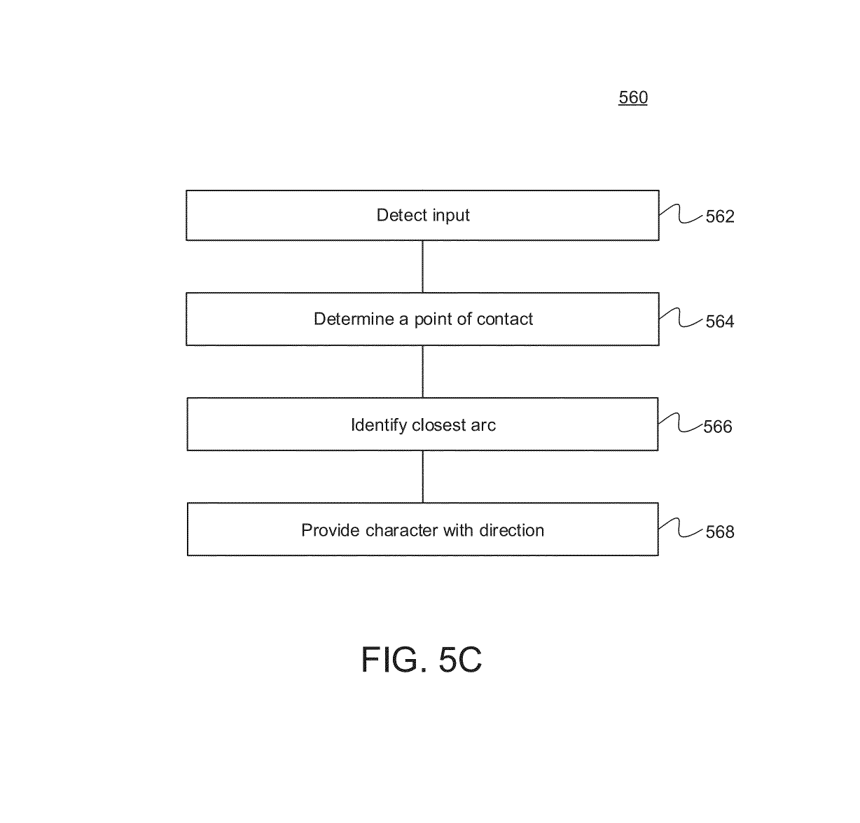

FIG. 5A is a simplified diagram illustrating a mechanism for controlling a character's movement in a battle game on a device 505. As described above, a status indicator 511 may indicate a position on a touchscreen 500 that may receive a user input to move a character 510 in the game environment. When a finger presses down on a first point of the touchscreen corresponding to a point on or near the status indicator 511, and pulls back in a swipe motion to a second point of the touchscreen, a control element 512 extends from the status indicator 511 at a position corresponding to the first point of the swipe,

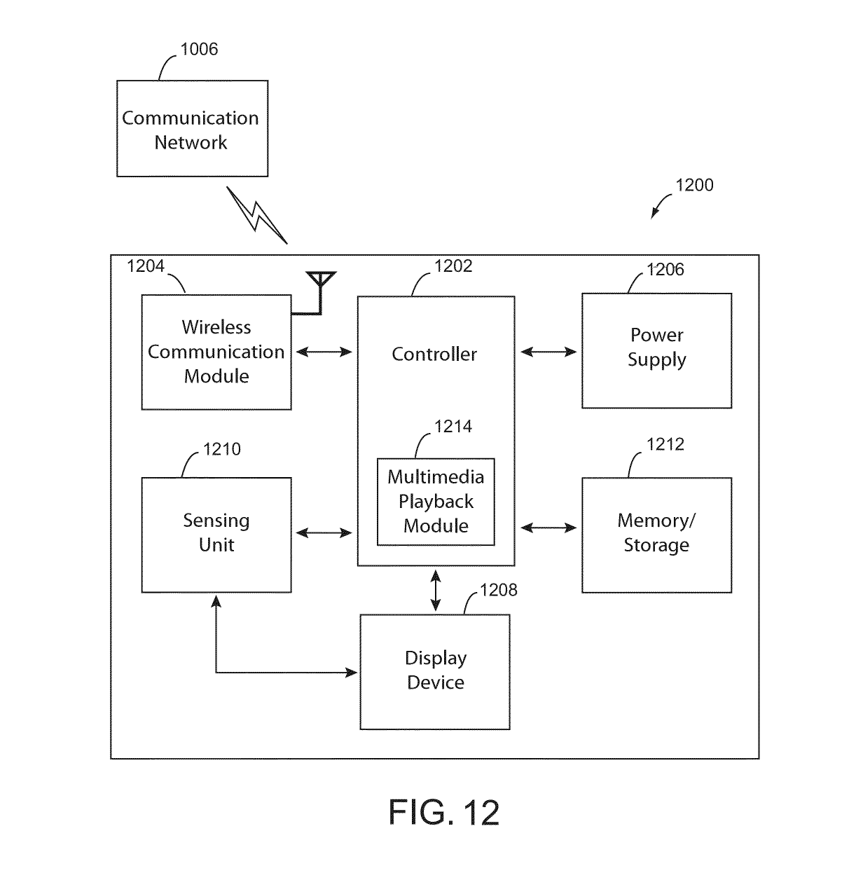

In an implementation, the user's input on the device 505 used by a controller (see, e.g., numeral 1202 of FIG. 12) of the device 505 to determine the moving direction of the character. The device 505 creates an image of the elongated control element 512 that extends along the line of the input swipe and indicates the moving direction of the character 510. As the user's finger moves in the swiping motion, the control element 512 stretches according to the user's flick action. The user's input is detected by the user's finger flick motion on the touchscreen 500, and the input is sent to the controller of the device 505. The controller determines a distance the first character 510 will move based on the user input. Based on the determination of the moving direction and moving length, the controller dynamically creates image data which depicts the first character 510 moving in the determined direction and by the determined length. According to an implementation, one or more operations performed by the controller of the device 505 may be offloaded to a game server remotely located from the device 505.

The direction of the character's movement is determined by the input made on the touchscreen 500, e.g., swiping a finger from the first point on the status indicator 511 adjacent to the first character 510, to a second point on the touchscreen 500. Components of the character's movement may be determined based on components of the input finger swipe. For example, the direction and distance of the character's movement may be obtained from the length and the direction of the swipe, respectively. Other components of the swipe, such as the duration of the swipe and the speed of the swipe, may also be used to determine aspects of the character's movement. For example, the speed/acceleration of the swipe or the length or duration of the swipe may be used to provide momentum to the character 510. In some implementations, as the speed/acceleration of the swipe increases, the character 510 may move more quickly. In other implementations, if the user continuously presses down at the second point of the swipe before releasing, the character's speed may increase.

In an embodiment, the direction the character moves corresponds to (or mirrors) the direction of the swipe 514. For example, in one embodiment, the first character 510 may move in the same direction as the swipe. In another embodiment, the character 510 may move in a direction 515 opposite to the swipe. In other words, the swipe may create a slingshot effect in that, when a finger presses down on a point of the touchscreen 500 on or near the status indicator 511 provided adjacent to the character 510, pulls back in a continuous swipe, and releases at a second point, the input causes the character 510 to move forward in the opposite direction.

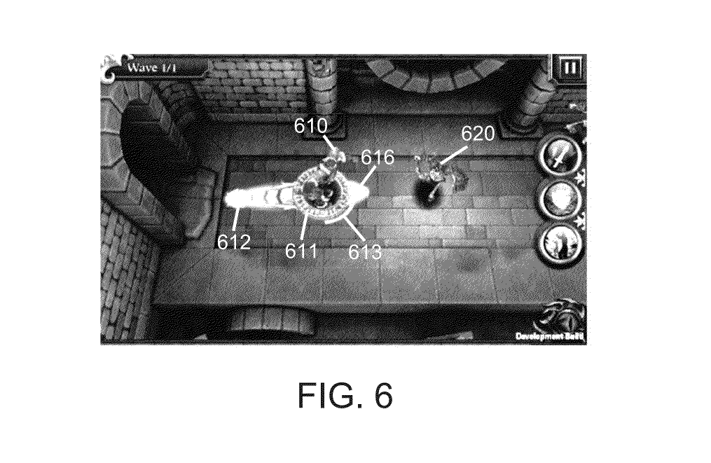

The control element 512, which corresponds to the input swipe, provides information about the character's movement to the user. The control element 512 extends along a line corresponding to the input swipe, and thus, indicates a direction of a character's movement. In an embodiment, the control element 512 tapers to a point in the direction 514, indicating the opposing course of the character's movement in the other direction 515. In an embodiment, the control element 512 may also include an arrow (616 of FIG. 6) in the direction 515 of the character's movement.

Similarly, the control element 512 may provide a visual indication of a distance the first character 510 will move. In an embodiment, the distance the first character 510 moves may correspond to the length of the swipe, i.e., the length from the first point to the second point. If the length of the swipe is longer, the character 510 may move a further distance. In this way, the user may easily adapt to using a control mechanism of the present invention, and adjust the length of swipe inputs to vary the distance the character 510 moves. In addition, the user can easily ascertain the projected distance the character 510 will move based on the displayed control element 512.

In an embodiment, the length of the swipe may be adjusted by moving the finger forward again before releasing. The length of the control element 512 is adjusted accordingly to indicate visually to the user the projected distance the character will move. Thus, the control element 512 may also allow the user to easily and accurately adjust the distance the character 510 will move. When the finger releases the swipe at a second point, the character 510 moves based on the input command.

The control element 512 may include other visual indicators. For example, the control element 512 may change colors, or the color of the control element 512 may vary in intensity according to the offensive effectiveness or defensive strength of the character 510. When the user inputs a swipe to move the character 510 toward an enemy 520, the user can visually obtain information from the control element 512 about an amount of damage that the character 510 may inflict on the enemy 520 or a likelihood that the character 510 can withstand an attack. In addition, in various embodiments, the offensive effectiveness and defensive strength of the character 510 may also be used to determine the speed and/or distance the character moves. In such embodiments, the control element 512 may also serve as a visual indicator of various components of the character's movement.

FIG. 5B illustrates a mechanism for controlling a character's movement using a status indicator 511′ that has a shape of a ring according to another embodiment. The status indicator 511′ encircles the character 510 when it is the character 510's turn in the battle. The status indicator 511′ is defined into a plurality of arcs 530-544. Each arc is associated with a particular direction component. The direction of a character's movement is based on the relationship between an input location of a user's command and the arcs proximate to the input location. In an embodiment, the moving direction of a character corresponds to the direction associated with the arc that is closest to an initial point of contact made by a user to input the command on the touchscreen. For example, if an input command 546 is made by contacting the touchscreen at a point 548 and swiping along the direction of an arrow 550, the character 510's moving direction corresponds to the direction associated with the arc 534.

FIG. 5C illustrates a process 560 for determining the direction of a movement of a character according to an embodiment. The process 560 is explained by referring to FIG. 5B. At 562, an input command (or swipe) is detected on a touchscreen. The location of a point of contact, e.g., an initial point of contact, is determined (564). The arc that is closest to the initial point of contact is identified, e.g., the arcs 534 (566). The character 510 is provided with the moving direction that is associated with the arc 534 (568).

FIG. 6 is a screenshot of a game environment showing a control element 612 according to an embodiment. As shown in FIG. 6, during a turn of the first character 610, the status indicator 611 is provided adjacent to the first character 610. In FIG. 6, the status indicator 611 is a ring and encircles the first character 610. The first character 611 is displayed across from a second character 620, i.e., a monster in a first wave of monsters.

The control element 612 is an elongated object extending from the ring-shaped status indicator 611. The control element 612 extends from the status indicator 611 in the direction of the swipe, and comes to a point indicating the opposing course of the character's projected movement. The control element 612 may also include an arrow 616 on a side of the status indicator 611 opposite to the side where the swipe is input, which points in the direction of the character's projected course towards the second character 620.

In an embodiment, the status indicator 611, the control element 612, and the timer 613 may be provided separately. By separating the ring-shaped status indicator 611, the timer 613, and the control element 612, which indicates the character's movement, the user is able to make a flick motion at any position on or near the control element 612, so that the user can easily adapt to controlling a relatively complicated mechanism for moving a character, hence usability of game features is improved.

In order to make the game more interesting to a user, various game features may be incorporated into the game. In an embodiment, the momentum of the character may also reflect the strength of the character or characteristics of the game environment. For example, the moving speed of a character may be further determined by the character's weight and the friction associated with the type of floor in the game environment. In an embodiment, the floor may be icy or wet, reducing friction. In other embodiments, types of floors may include fields having burning elements or embedded nails, which may inflict damage on characters.

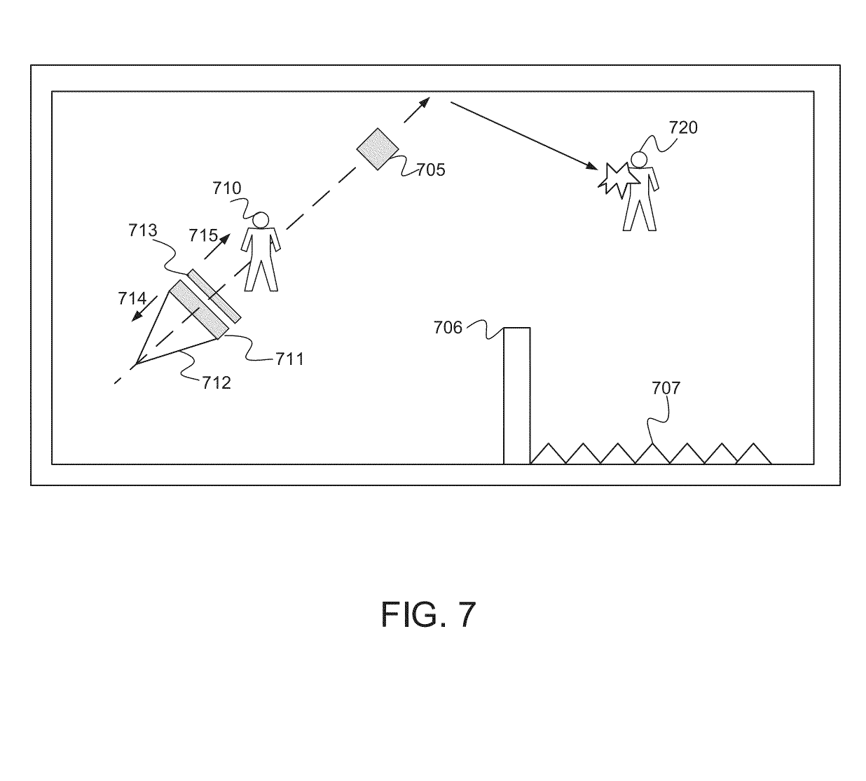

FIG. 7 is a simplified diagram of a game environment including various game features. The game environment may include placeables 705, such as a toxic or explosive barrel or a bomb, which a first character 710 can move or push, barriers 706, which can stop the movement of characters and enemies, and wall elements 707, such as wall spikes or tunnels, which can inflict damage to characters and enemies. The game environment may also include other game features, such as a trap, which is activated at a predetermined turn. For example, if the character is located in a predetermined area in the game environment during a predetermined time period in the mission, the trap is activated so that it damages the character. Some placeables 705, such as a bomb, may be placed in the environment to damage characters located within a predetermined distance from the bomb when a blast takes place.

When the first character 710 moves in a battle game based on an input swipe motion, at the end of the movement, the character 710 may attack an enemy 720 to inflict damage, or may collide with the enemy 720 to push the enemy 720. That is, in the battle, the first character 710 collides with the second character 720 by way of the moving action. In an embodiment, when the character 710 collides with an enemy 720 or placeable 705, the character 710 may push the enemy 720 or placeable 705. A combination of collisions increases the amount of damage inflicted on the enemy 720.

As the number of collisions increases, the amount of damage inflicted increases. If the enemy 720 is pushed and collides with a wall, and then collides with another enemy, the amount of damage inflicted on the enemy 720 would be greater than that inflicted if the character 710 had simply collided with the enemy 720. In various embodiments, collisions may occur between the enemy 720 and other enemies 720, other characters, and game elements such as placeables 705, barriers 706, and wall elements 707.

In a battle game, the speed of the character 710 is used to calculate push force, That is, when the character 710 collides with a placeable 705 or an enemy 720, the character 710 may push the placeable 705 or enemy 720. The distance the placeable 705 or enemy 720 is pushed may be calculated based on the speed of the character 710. Similarly, various enemies, e.g., monsters, may be assigned base statistics associated with offensive effectiveness, defensive strength, and friction, which may be used to determine the amount of damage the monster may inflict, the momentum, and the push force of the monster.

To enhance a user's enjoyment of a game, a game may allow the first character's user to participate with other users in a mission or battle. The first character 710 may cooperate with another character, i.e., a third character, in a battle or mission. In an embodiment, the first character's user may invite the user of the third character, who is associated with the first character's user via the user's social network, to be an ally in a mission or battle. Once the third character' user is invited, a registration screen is shown on the third character's user's screen so he or she is able to register to play the game and create the third character to continue the game. Additionally, a user may merely elect to use one of characters of the user's allies without getting the ally involved in the actual game played by the user.

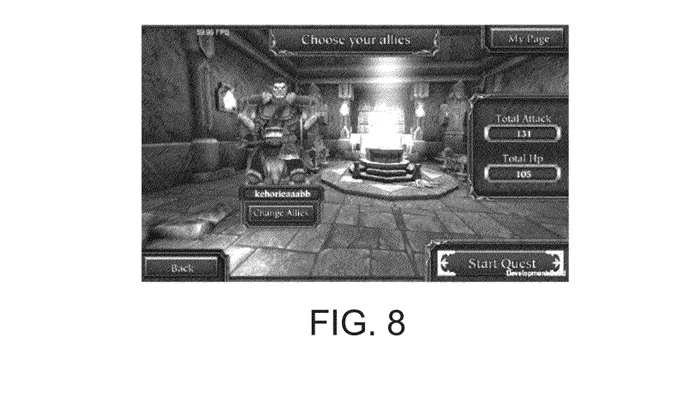

FIG. 8 shows a screen shot of an ally selection screen. As with other characters, a third character ally may have an offensive strength, which may be represented numerically by a Total Attack value, and a defensive effectiveness, which may be represented by a Total Hit Points (RP) value. Such values may assist a user in selecting an ally. In an embodiment, the first character and third character may play the game together synchronously. In another embodiment, the first character's user may control the third character while the third character's user is offline. If the third character is selected as an ally, the third character's user may be rewarded. Repeated use of a third character may advance the third character's strength or experience level, which may develop the character's role and skills associated with the character's role.

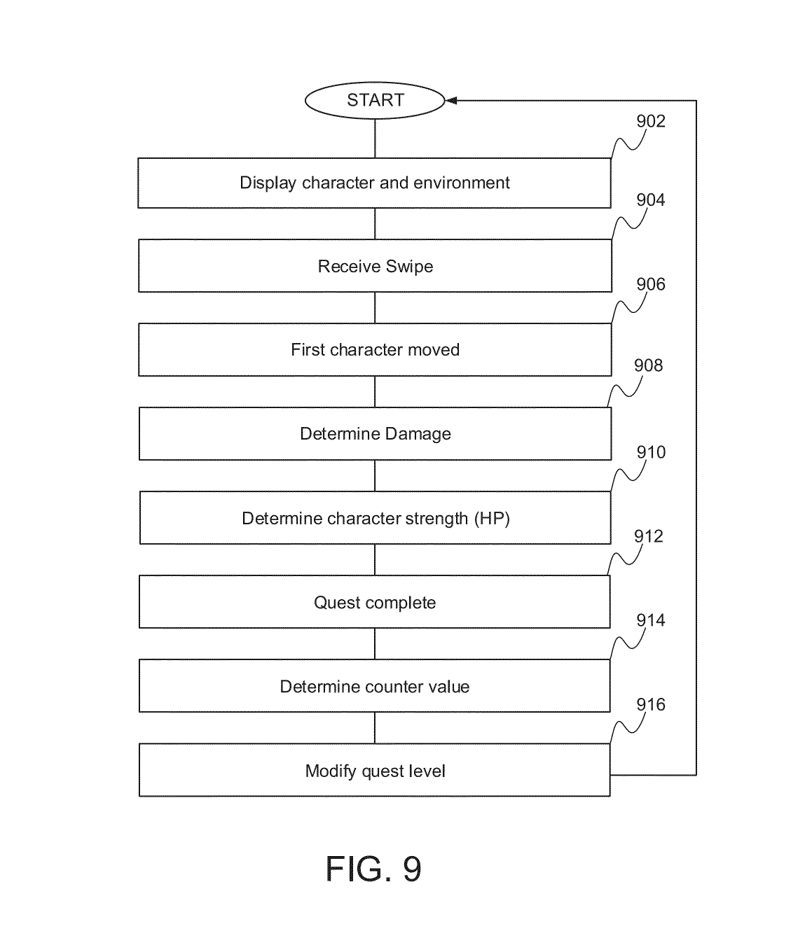

FIG. 9 illustrates a process 900 for playing a game according to an embodiment. A video game may be downloaded from a server onto a user device. After the video game is launched at the START step, a character and a game environment are displayed at 902. A status indicator may be displayed adjacent to an active character to indicate to a player which character's turn it is. The game may provide a quest to the user device. In the quest, the active character may engage in a turn-based battle. The active character may begin the quest at an initial level. The initial level of the character may be associated with the character's experience in previously played games or quests.

A finger swipe is received by the touchscreen of the user device at 904 and a control element is displayed corresponding to the input finger swipe. The input finger swipe is used to determine the character's movement. For example, the distance, direction, and speed of the character's movement are based on components of the finger swipe. In an embodiment, the speed of the character's movement is determined also based on the weight of the character and the surface friction of the environment.

The character is moved at 906, and may collide with another character, such as a monster, to inflict damage on the monster. At 908, the amount of damage inflicted on the monster is determined. The amount of damage inflicted may be determined based on a plurality of factors, including, for example, the character's strength and a number of collisions with the monster that are caused by the character's movement.

The character's strength, represented by RP, may be assessed after the attack at 910. If damage was inflicted on the character in the battle, the character's strength may be decreased. The quest is completed at 912 and a counter value associated with the character's level is determined at 914. If the character completes the quest with a strength or HP value that exceeds a predetermined value, the counter is incremented to increase the character's initial level. If the character loses, withdraws from the quest, or completes the quest with less than a predetermine HP value, the counter is decremented.

At 916, it is determined whether the counter exceeds a predetermined threshold. value associated with the quest level of the game. If the counter exceeds a threshold value, the quest level of the game will be modified, and another game environment may be displayed having more advanced game features. If the counter is less than a predetermined threshold, the quest level may be decreased, and a simpler game environment may be displayed in the character's next quest. In embodiments, the quest level may not be modified until the counter reaches the predetermined threshold value a predetermined number of times.

To entertain the user, the angle of a 3D virtual camera may be changed based on a user's action. For example, if a critical hit, a combination of attacks, or the skill unique to a class of the character is activated, the camera angle may change from a default angle, which may be an isometric view, to a top view. The virtual camera may also pan around the character when the character performs an action.

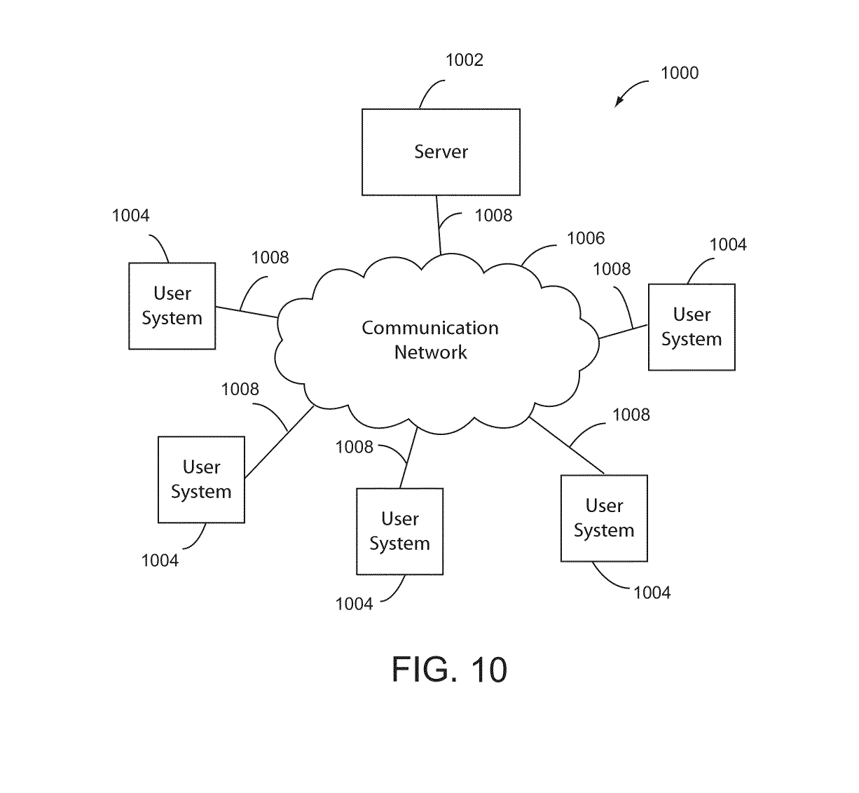

FIG. 10 shows a simplified view of a communications system 1000. The communication system 1000 comprises a server 1002 which is in communication with a communications network 1006 via a communications link 1008. A plurality of user systems 251004 are in communication with the communications network via links 1008, and can download games and other information from the server 1002. Server 1002 may provide the backend support for playing the video game. For example, the friend's list and random appearance of other players may be coordinated by server 1002. Server 1002 also enables the user systems to download the game, send alerts or messages to the user systems and provide updates to the game.

User systems 1004 may be smart phones, tablets, laptops, all-in-one computers, or any other computing device that is suitable for playing video games. The user system should have a screen to display the video and an input device to input commands. Both of these functionalities can be provided by a touchscreen. Communication links 1008 may be of the wired or wireless variety. Similarly, the communications network itself may comprise wired and/or wireless components.

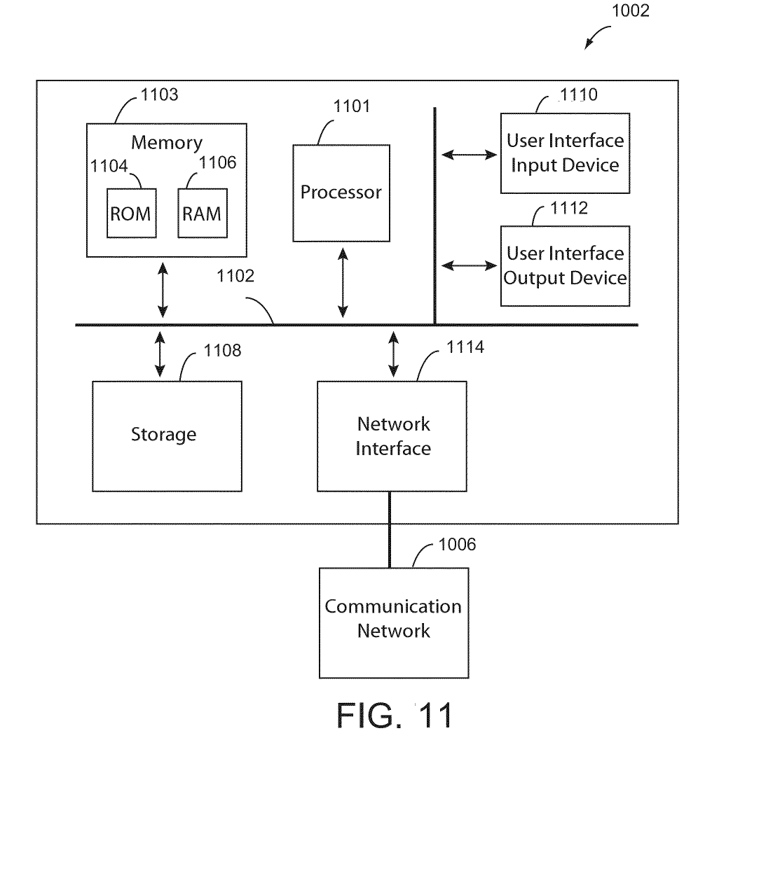

FIG. 11 shows a simplified view of components in server 1002 in FIG. 10. Server 1002 comprises a processor or CPU 1101 that is in communication with a variety of other elements via a bus 1102. Such other components of the server include but are not limited to a non-transitory computer readable storage medium as a memory 1103, including a Read Only Memory (ROM) 1104 and a Random Access Memory (RAM) 1106, and also a higher capacity non-transitory computer readable storage medium 1108. One or more of these elements may be employed by the server to store the computer code representing the instructions for operating the video game. This computer code may be sent from the server over the communication network to a user device, to allow a user to download the video game.

An administrator or other authorized personnel may communicate with the server via a user interface input device 1110 (e.g. a keyboard, mouse), for example to update or modify the code being disseminated to the various user devices. The administrator or other authorized personnel may receive information from the server via a user interface output device 1112 such as a display screen. This received information may comprise user registrations and/or subscriptions.

Server 1002 includes a network interface 1114 that is configured to allow information to be communicated between the server and the communications network. An example of such information is the computer code that is executable on the user system to run the video game. Although FIG. 11 illustrates the components of server 1002, some of user systems 1004 may have the same or similar components thereto.

FIG. 12 shows a simplified view of a user device 1200 which is a type of user systems 1004. User device 1200 may be a smart phone or tablet and includes a controller 1202 for controlling the operation of the user device, a wireless communication module 1204 for communicating with a network, a power supply 1206, a display device 1208, a sensing unit 1210, and a memory/storage unit 1212.

Wireless communications module 1206 is used to communicate with a wireless network and receive a video game from server 1002. The video game or data file received from the server is stored in the memory/storage unit 1212 using controller 1202. The video game comprises computer code for executing various steps needed to play the video game. Once the game is downloaded to the storage unit, the user device can play the game without being connected to server 1002. Alternatively, the game may require user device 1200 to remain in communication with server 1002 to play the game, or at least receive a key or a portion of the video game each time the user wishes to launch the game.

The video game is launched and played using a multimedia playback module 1214. The video game is displayed on display device 1208 (e.g. a touchscreen) that can also receive inputs from a user. Sensing unit 1210 senses inputs made on the touchscreen including the swiping, motions and amounts of downward force exerted thereon. Controller 1202 determines a direction and distance based on the input sensed by the sensing unit.

As described above, an embodiment of the present invention may provide an increasingly complex turn-based battle video game. Embodiments of the present invention allow users of varying skill levels to play the video game by simplifying a mechanism for controlling a movement of a character in the game. Embodiments also provide various visual cues to users to enable them to quickly and easily determine a turn status of a character, and characteristics of the character's predicted motion.

Having thus described embodiments of the present invention, it should be noted by those skilled in the art that the disclosures within are exemplary only, and that various other alternatives, adaptations, and modifications are possible. For example, swiping motions inputted on a touchscreen can be replaced with flicking or similar motions. Also the swiping motions or the like may be input on a device other than a touchscreen, e.g., a touchpad and a motion sensor including a camera. Accordingly, embodiments are not limited to the specific structures or methods as illustrated and taught herein.

What is claimed is:

1. A system comprising:
a processor;
a network interface to receive a request from a user for a video game download; and
a non-transitory computer-readable medium having stored thereon a program for playing a turn-based battle video game that utilizes a touchscreen to receive inputs from a user, the non-transitory computer-readable medium including:
code for displaying an environment;
code for displaying a first character;
code for displaying a status indicator adjacent to the first character;
code for receiving an input extending from a first point of the touchscreen corresponding to a position on the status indicator and extends to a second point on the touchscreen, the input having a direction component and a length component, the direction component corresponding to a first direction; and
code for causing a movement of the first character, the movement corresponding to the input.

2. The system of claim 1, wherein the input is a swiping motion extends continuously from the first point to the second point on the touchscreen using a finger.

3. The system of claim 2, further comprising code for displaying a control element corresponding to the input to indicate the movement of the first character, wherein the second object is an elongated object extending along a line.

4. The system of claim 1, further comprising code for displaying a time indicator provided adjacent to the first character, wherein a length of the time indicator corresponds to a timer indicating a length of the turn of the first character.

5. The system of claim 2, wherein the input is used to determine a distance and a direction of a movement of the first character, and wherein the program further includes code for causing the movement of the first character to reflect the distance and the direction.

6. The system of claim 5, wherein a speed of the movement of the character is determined based on a plurality of factors, the plurality of factors including any one of an attack power of the first character, an attribute of the first character, a weight of the first character, and a friction of a floor in the environment.

7. The system of claim 2, further comprising code for determining whether the first character has caused damage to a second character, an amount of damage being determined based on an attack power of the first character.

8. The system of claim 7, wherein the amount of damage is further determined based on a number of collisions between a game element and the second character, wherein the object is any of the first character, a third character, a barrier, and a placeable.

9. The system of claim 2, further comprising code for causing a second character to be pushed a distance by a collision caused by a movement of the first character based on the input, wherein the distance is determined by a speed of the movement of the first character.

10. The system of claim 1, further comprising:
code for displaying a time indicator provided adjacent to the first character, wherein a length of the time indicator corresponds to a timer indicating a length of the turn of the first character,
wherein the status indicator is a ring shape encircling the first character.

11. The system of claim 10, wherein the time indicator is an arc provided along an edge of the ring shape of the status indicator.

12. The system of claim 11, wherein the movement of the first character is in a direction opposing the first direction of the input, and
wherein a speed of the movement of the character is determined based on a plurality of factors, the plurality of factors including a weight of the first character and a friction of a floor in the environment.

13. A method for providing a turn-based battle game on a mobile device having a touchscreen, the method comprising:
displaying an environment including an active first character on the touchscreen;
displaying a status indicator adjacent to the active first character;
receiving an input on the touchscreen that extends from a first point on the touchscreen corresponding to a point on the status indicator to a second point on the touchscreen, the input having a direction component and a length component, the direction component corresponding to a first direction; and
causing a movement of the active first character based on the input, a distance and a direction of the movement of the first character being determined based on the input.

14. The method of claim 13, further comprising displaying a control element corresponding to the input, the control element including direction information and distance information associated with the character movement.

15. The method of claim 13, further comprising causing the active first character to collide with a second character, and determining an amount of damage inflicted on the second character.

16. The method of claim 13, further comprising:
displaying a control element corresponding to the input to indicate the movement of the first character, wherein the second object is an elongated object extending along a line;
displaying a time indicator provided adjacent to the first character, wherein a length of the time indicator corresponds to a timer indicating a length of the turn of the first character,
wherein the input is used to determine a distance and a direction of a movement of the first character, and
wherein a speed of the movement of the character is determined based on a plurality of factors, the plurality of factors including a weight of the first character and a friction of a floor in the environment.

17. The method of claim 13, further comprising:
displaying a time indicator provided adjacent to the first character, wherein a length of the time indicator corresponds to a timer indicating a length of the turn of the first character,
wherein the status indicator is a ring shape encircling the first character, and the time indicator is an arc provided along an edge of the ring shape of the status indicator.

18. A non-transitory computer readable medium stored thereon a program for playing a turn-based battle video game that utilizes a touchscreen to receive inputs from a user, the non-transitory computer medium comprising:
code for displaying an environment;
code for displaying a first character;
code for displaying a status indicator adjacent to the first character;
code for receiving an input extending from a first point of the touchscreen corresponding to a position on the status indicator and extends to a second point on the touchscreen, the input having a direction component and a length component, the direction component corresponding to a first direction; and
code for causing a movement of the first character, the movement corresponding to the input.

19. The non-transitory computer-readable medium of claim 18, further comprising,
code for displaying a control element corresponding to the input to indicate the movement of the first character, wherein the second object is an elongated object extending along a line;
code for displaying a time indicator provided adjacent to the first character, wherein a length of the time indicator corresponds to a timer indicating a length of the turn of the first character,
wherein the input is used to determine a distance and a direction of a movement of the first character, and
wherein a speed of the movement of the character is determined based on a plurality of factors, the plurality of factors including a weight of the first character and a friction of a floor in the environment,

20. The non-transitory computer-readable medium of claim 18, further comprising:
code displaying a time indicator provided adjacent to the first character, wherein a length of the time indicator corresponds to a timer indicating a length of the turn of the first character,
wherein the status indicator is a ring shape encircling the first character, and the time indicator is an arc provided along an edge of the ring shape of the status indicator.
